(19) United States
(12) Patent Application Publication
(10) Pub. No.: US 2017/0132990 A1
(43) Pub. Date: May 11, 2017

(54) METHOD AND SYSTEM OF REDUCING POWER CONSUMPTION OF A MOBILE TERMINAL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Quanhua HE, Beijing (CN); Hao ZHANG, Beijing (CN); Lingyun SHI, Beijing (CN); Qingfang BIAN, Beijing (CN); Guangquan WANG, Beijing (CN); Xue DONG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/108,877

(22) PCT Filed: Jan. 15, 2016
(86) PCT No.: PCT/CN2016/071002

§ 371 Date: Jun. 29, 2016

(30) Foreign Application Priority Data
Jul. 17, 2015 (CN) 201510424274.8

(51) Int. Cl. G09G 5/22; H04W 52/02

(52) U.S. Cl. CPC G09G 5/227; H04W 52/027; G09G 2330/021; G09G 2310/0267; G09G 2310/0275; G09G 2360/12; G09G 2340/16; G09G 2340/0414; G09G 2340/0421; G09G 2340/0435

(57) ABSTRACT

There are provided a method and system of reducing power consumption of the mobile terminal. The method comprises following steps: determining whether picture information to be displayed currently in the mobile terminal belongs to picture information of a first mode, the picture information of the first mode being picture information of a low quality display requirement (101); and reducing a transmission rate of a mobile industry processor interface of the mobile terminal and/or making a display screen of the mobile terminal operate in a low power consumption mode if the picture information to be displayed currently belongs to the picture information of the first mode (102). The method and system of reducing power consumption of the mobile terminal adopt at least one mode of reducing the MIPI transmission rate of the mobile terminal and making the display screen operate in the low power consumption mode in a mode that requires relatively low performance of the mobile terminal, by determining an operating mode of the mobile terminal, to reduce overall power consumption of the mobile terminal.

### TECHNICAL FIELD

The present disclosure relates to a technical field of a mobile terminal, in particular to a method and system of reducing power consumption of a mobile terminal.

### BACKGROUND

At present, a mobile terminal represented by a smart phone and a tablet personal computer (Tablet PC) provides greater and greater functions, for example, mobile communication, office affairs, entertainments, etc., while the mobile terminals consumes more and more power.

In a normal state, transmission rate of a mobile industry processor interface (MIPI) in the mobile terminal would be usually set to satisfy with the highest requirement, and parameters such as luminance and resolution ratio of a display screen would be also set to satisfy with the highest requirement. In order to reduce the power consumption of the mobile terminal, in the prior art, when the mobile terminal is in a standby state, its backlight is darkened, or its display screen is turned off, so as to reduce the power consumption of the mobile terminal. However, such manner can solve the power consumption problem only when the mobile terminal is in the standby state, but fails to provide an efficient method of reducing power consumption to reduce power consumption when the mobile terminal is in a normal state.

### SUMMARY

There is provided in embodiments of the present disclosure a method and system for reducing power consumption of a mobile terminal, to solve the problem of relatively high power consumption when the mobile terminal is in a normal state.

There is provided in an embodiment of the present disclosure a method of reducing power consumption of a mobile terminal, comprising:

determining whether picture information to be displayed currently in the mobile terminal belongs to picture information of a first mode, the picture information of the first mode being picture information of a low quality display requirement;

reducing a transmission rate of a mobile industry processor interface of the mobile terminal and/or making a display screen of the mobile terminal operate in a low power consumption mode if the picture information to be displayed currently belongs to the picture information of the first mode.

In the present embodiment, by determining an operating mode of the mobile terminal, in a mode that requires relatively low performance of the mobile terminal, at least one mode of reducing the MIPI transmission rate of the mobile terminal and making the display screen operate in the low power consumption mode is adopted to reduce overall power consumption of the mobile terminal.

Alternatively, the first mode comprises a text display mode and a picture display mode.

Alternatively, making the display screen of the mobile terminal operate in a low power consumption mode comprises: reducing resolution ratio or refresh rate of the display screen of the mobile terminal. In the present embodiment, the power consumption of the display screen is reduced by reducing the resolution ratio or refresh rate of the display screen of the mobile terminal, so that the overall power consumption of the mobile terminal is reduced.

Alternatively, reducing the resolution ratio of the display screen of the mobile terminal in particular comprises: within one frame time, making a data driving integrated circuit select only a part of data lines connected to the display screen to transmit data signals corresponding to picture information of the frame time, and/or making a gate driver on array (GOA) circuit or a gate driving integrated circuit select only a part of gate lines connected to the display screen to transmit gate driving signals. In the present embodiment, resolution ratio is reduced by using only a part of data lines and/or only a part of gate lines for transmission, which reduces power consumption of data driving chip or integrated circuit or gate driving chip or integrated circuit in the display screen, so that the overall power consumption of the mobile terminal is reduced.

Alternatively, adjacent pixels connected to the data lines selected for transmission constitute vertical active display areas, adjacent pixels connected to the data lines not selected for transmission constitute vertical inactive display areas, and the vertical active display area and the vertical inactive display area are arranged at intervals; and/or

adjacent pixels connected to the gate lines selected for transmission constitute horizontal active display regions, adjacent pixels connected to the gate lines not selected for transmission constitute horizontal inactive display areas, and the horizontal active display area and the horizontal inactive display area are arranged at intervals.

In the present embodiment, the resolution ratio of the display screen is reduced by using only a part of data lines and/or only a part of gate lines for transmission, and at the same time, the display is made uniform and influence on the display effect is reduced by adjusting the distribution of the data lines and/or the gate lines which are not used for outputting.

Alternatively, making the display screen of the mobile terminal operate in a low power consumption mode further comprises: comparing difference between picture information of a current frame and picture information of a previous frame, and transmitting data signals only for pixels whose pixel luminance changes.

In the present embodiment, only the data whose luminance (gray scale value) changes in the picture pixel is transmitted, so that data transmission amount is reduced, and power consumption is reduced.

The embodiment of the present disclosure has following beneficial effects: by determining an operating mode of the mobile terminal, in a mode that requires relatively low performance of the mobile terminal, adopting at least one mode of reducing the MIPI transmission rate of the mobile terminal and making the display screen operate in the low power consumption mode to reduce overall power consumption of the mobile terminal.

There is provided in an embodiment of the present disclosure a system of reducing power consumption of a mobile terminal, comprising:

a determining unit, configured to determine whether picture information to be displayed currently in the mobile terminal belongs to picture information of a first mode, the picture information of the first mode being picture information of a low quality display requirement;

a controlling unit, configured to reduce a transmission rate of a mobile industry processor interface of the mobile terminal and/or making a display screen of the mobile terminal operate in a low power consumption mode if the picture information to be displayed currently belongs to the picture information of the first mode.

In the present embodiment, by determining an operating mode of the mobile terminal, in a mode that requires relatively low performance of the mobile terminal, at least one mode of reducing the MIPI transmission rate of the mobile terminal and operating the display screen in the low power consumption mode is adopted to reduce overall power consumption of the mobile terminal.

Alternatively, the first mode comprises a text display mode and a picture display mode.

Alternatively, in order to operate the display screen of the mobile terminal in a low power consumption mode, the controlling unit comprises:

means for reducing a resolution ratio or refresh rate of the display screen of the mobile terminal.

In the present embodiment, the controlling unit reduces the power consumption of the display screen by reducing the resolution ratio or refresh rate of the display screen of the mobile terminal, so that the overall power consumption of the mobile terminal is reduced.

Alternatively, the reducing the resolution ratio of the display screen of the mobile terminal comprises:

within one frame time, making a data driving integrated circuit select only a part of data lines connected to the display screen to transmit data signals corresponding to picture information of the frame time, and/or making a gate driver on array (GOA) circuit or a gate driving integrated circuit select only a part of gate lines connected to the display screen to transmit gate driving signals. In the present embodiment, the resolution ratio is reduced by using only a part of data lines for outputting, which reduces power consumption of data driving chip or integrated circuit in the display screen, so that the overall power consumption of the mobile terminal is reduced.

Alternatively, adjacent pixels connected to the data lines selected for transmission constitute vertical active display areas, adjacent pixels connected to the data lines not selected for transmission constitute vertical inactive display areas, and the vertical active display areas and the vertical inactive display areas are arranged at intervals; and/or

adjacent pixels connected to the gate lines selected for transmission constitute horizontal active display regions, adjacent pixels connected to the gate lines not selected for transmission constitute horizontal inactive display areas, and the horizontal active display areas and the horizontal inactive display areas are arranged at intervals.

In the present embodiment, the resolution ratio of the display screen is reduced by using only a part of data lines and/or only a part of gate lines for transmission while distribution of the data lines and/or the gate lines not used for outputting is adjusted, so that display would be uniform and influence on the display effect is reduced.

Alternatively, in order to make the display screen of the mobile terminal operate in a low power consumption mode, the controlling unit further comprises: means for comparing difference between picture information of a current frame and picture information of a previous frame, and transmitting data signals only for pixels whose pixel luminance changes.

In the present embodiment, the controlling unit controls the mobile terminal to transmit only data in the picture pixel that has luminance (gray scale value) change, so that data transmission amount is reduced, and power consumption is reduced.

The embodiment of the present disclosure has following beneficial effects: by determining an operating mode of the mobile terminal, in a mode that requires relatively low performance of the mobile terminal, adopting at least one mode of reducing the MIPI transmission rate of the mobile terminal and making the display screen operate in the low power consumption mode to reduce overall power consumption of the mobile terminal.

### BRIEF DESCRIPTION OF THE DRAWINGS

FIG. 1 is a flow diagram of a method of reducing power consumption of the mobile terminal provided in an embodiment of the present disclosure;

FIG. 2 is a schematic diagram of selecting ½ data lines to transmit a data signal corresponding to picture information of a frame time provided in an embodiment of the present disclosure;

FIG. 3 is a schematic diagram of selecting ¾ data lines to transmit a data signal corresponding to picture information of a frame time provided in an embodiment of the present disclosure;

FIG. 4 is a schematic diagram of selecting ⅗ data lines to transmit a data signal corresponding to picture information of a frame time provided in an embodiment of the present disclosure;

FIG. 5 is a block diagram of a system of reducing power consumption of a mobile terminal provided in an embodiment of the present disclosure.

### DETAILED DESCRIPTION

Implementation process of embodiments of the present disclosure will be described in detail by combining with the drawings of the specification. It needs to note that same or similar reference marks always represent same or similar elements or elements having same or similar functions. Following embodiments described by referring to the figures are illustrative, and are only used to explain the present disclosure, but cannot be understood as a limitation to the present disclosure.

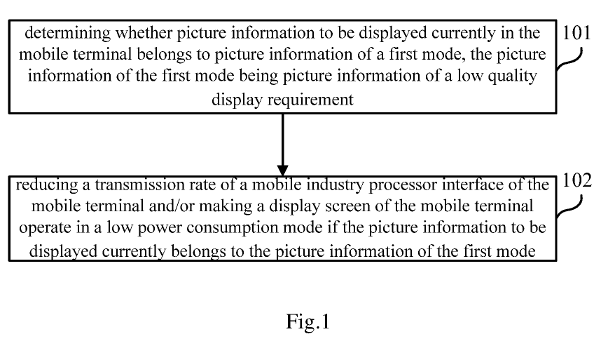

FIG. 1 shows a method of reducing power consumption of a mobile terminal provided in an embodiment of the present disclosure. As shown in FIG. 1, the method comprises following operating processes:

in step 101, determining whether picture information of the mobile terminal to be displayed currently belongs to picture information of a first mode, the picture information of the first mode is picture information of a low quality display requirement;

in step 102, reducing a transmission rate of a mobile industry processor interface of the mobile terminal and/or making a display screen of the mobile terminal operate in a low power consumption mode if the picture information to be displayed currently belongs to the picture information of the first mode.

In the present embodiment, the first mode may be a text displaying mode, a picture displaying mode or a mode of low quality display requirement prescribed by a user. Specifically, for example, a webpage displaying mode, an electronic book mode, a picture preview mode, etc.

It needs to note that if it is determined that the picture information of the mobile terminal to be displayed currently does not belong to the picture information of the first mode, for example, being a game mode or a video mode, then the MIPI transmission rate of the mobile terminal is made to satisfy the highest requirement, and also the display screen is made to operate in a state that satisfies the highest requirement. If the picture information of the first mode is being displayed and the display screen of the mobile terminal has been already operated in the low power consumption mode, at this time, the MIPI transmission rate of the mobile terminal can be recovered simultaneously to satisfy the highest requirement when the mode is converted into the game mode or the video mode, and of course, the display screen of the mobile terminal can also be recovered to the state that satisfies the highest requirement, to which no further description is given herein.

In the present embodiment, by determining an operating mode of the mobile terminal, in a mode that requires relatively low performance of the mobile terminal, at least one mode of reducing the MIPI transmission rate of the mobile terminal and making the display screen operate in the low power consumption mode is adopted to reduce overall power consumption of the mobile terminal.

Alternatively, in step 102, making the display screen of the mobile terminal operate in the low power consumption mode comprises: reducing a resolution ratio or a refresh rate of the display screen of the mobile terminal. The power consumption of the display screen is reduced by reducing the resolution ratio or refresh rate of the display screen of the mobile terminal, so that the overall power consumption of the mobile terminal is reduced. In particular, for example, reducing the resolution ratio of the display screen of the mobile terminal can be implemented in the following manners: within one frame time, making a data driving integrated circuit only select a part of data lines connected to the display screen to transmit a data signal corresponding to picture information of the frame time, and/or making a gate driver on array (GOA) circuit or a gate driving integrated circuit only select a part of gate lines connected to the display screen to transmit a gate driving signal. That is, 1/N data lines can be selected as a valid transmission line for the data signal, and/or a part of gate lines is selected to transmit a gate driving signal to drive a gate of a thin film transistor, so that only part of columns and/or rows of pixels of the display screen are used for displaying the picture information, where N is an integer greater than or equal to 2. Description is given below by taking data lines “data” as an example.

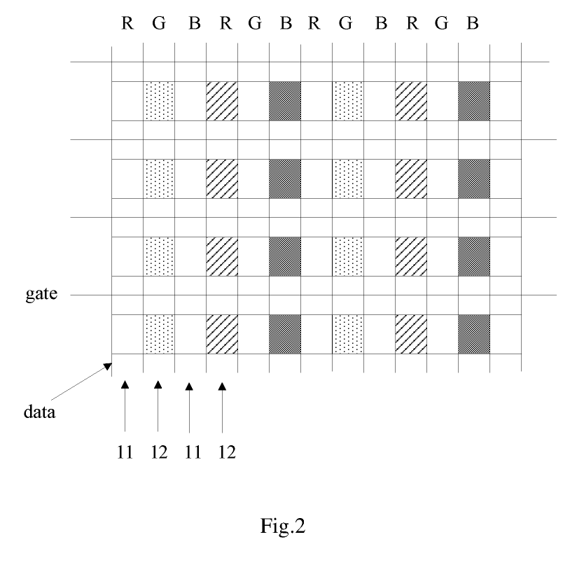

For example, FIG. 2 shows a schematic diagram of selecting ½ data lines to transmit a data signal corresponding to picture information of the frame time provided in an embodiment of the present disclosure. Referring to FIG. 2, only ½ data lines “data” are selected to transmit the data signals corresponding to the picture information of the frame time, i.e., making the resolution ratio reduced to ½ of that in the normal state. Actually, in this case, since amount of the output data is reduced, the MIPI transmission rate can be reduced in a corresponding proportion.

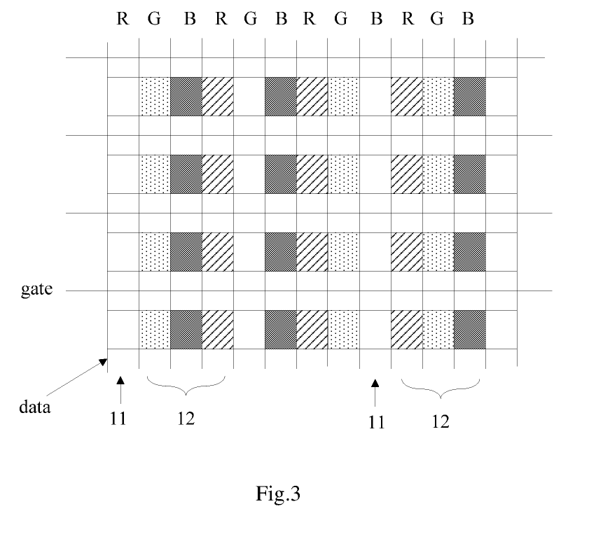

For another example, FIG. 3 shows a schematic diagram of selecting ¾ data lines to transmit data signals corresponding to picture information of the frame time provided in an embodiment of the present disclosure. Referring to FIG. 3, only ¾ data lines “data” are selected to transmit the data signals corresponding to the picture information of the frame time, that is, making the resolution ratio reduced to ¾ of that in the normal state.

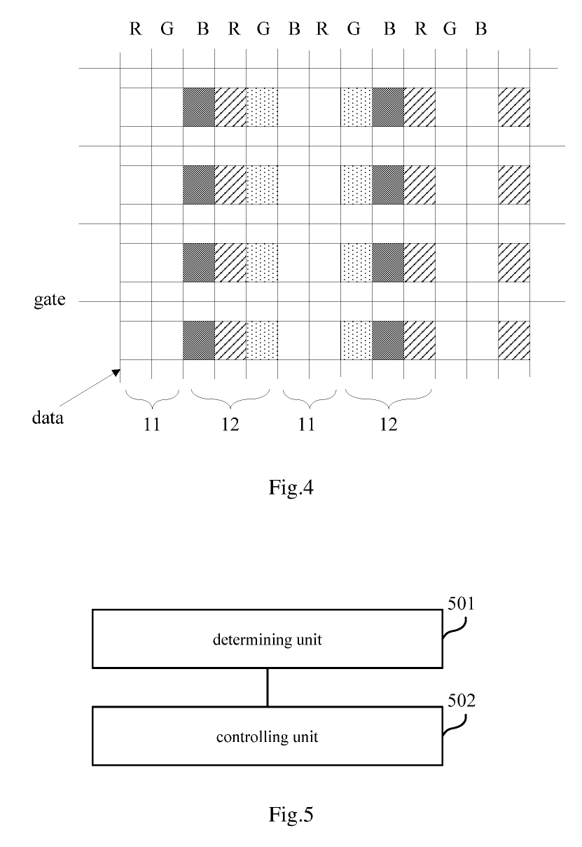

For another example, FIG. 4 is a schematic diagram of selecting ⅗ data lines to transmit a data signal corresponding to picture information of the frame time provided in an embodiment of the present disclosure. Referring to FIG. 4, only ⅗ data lines “data” are selected to transmit the data signal corresponding to the picture information of the frame time, i.e., making the resolution ratio reduced to ⅗ of that in the normal state. In the present embodiment, the resolution ratio is reduced by using only a part of data lines “data” for outputting to reduce power consumption of data driving chip or integrated circuit in the display screen, so that the overall power consumption of the mobile terminal is reduced. Of course, a similar selection can also be made for gate lines “gate”, to which further description is given herein.

Alternatively, pixels connected to the adjacent data lines “data” selected for transmission constitute active display areas 12 in a column (vertical) direction, pixels connected to the adjacent data lines “data” not selected for transmission constitute the vertical inactive display areas 11, and the vertical active display areas 12 and the vertical inactive display areas 11 are arranged at intervals; and/or

pixels (pixels R, G, B as shown in FIGS. 2-4) connected to the adjacent gate lines “gate” selected for transmission constitute horizontal active display regions, pixels connected to the adjacent gate lines “gate” not selected for transmission constitute horizontal inactive display areas, and the horizontal active display areas and the horizontal inactive display areas are arranged at intervals.

Further description will be given below by taking the data lines “data” as an example. For example, in FIG. 2, the unselected data lines “data” and the data lines “data” used for transmission are distributed at intervals, such that the vertical active display areas 12 and the vertical inactive display areas 11 are distributed at intervals, and thus pixels are lightened at intervals of a column; for another example, in FIG. 3, at intervals of one data line “data”, there are three data lines “data” for transmission, such that the vertical active display areas 12 includes three adjacent columns of pixels, and the vertical active display areas 12 and the vertical inactive display areas 11 are distributed at intervals, and thus three columns of pixels are lightened at intervals of one column of pixels; for another example, in FIG. 4, at intervals of two data lines “data”, there are three data lines “data” for transmission, such that the vertical active display areas 12 includes three adjacent columns of pixels, and the vertical inactive display areas 11 includes two adjacent columns of pixels; the vertical active display areas 12 and the vertical inactive display areas 11 are distributed at intervals, and thus at intervals of two columns of pixels, three adjacent columns of pixels are lightened. In the present embodiment, the resolution ratio of the display screen is reduced by using only a part of data lines “data” and/or only a part of gate lines “gate” for transmission while distribution of the data lines and/or the gate lines not used for outputting is adjusted, so that display would be uniform and influence on the display effect is reduced.

It needs to note that selection of a part of gate lines “gate” has a principle similar to the selection of data lines “data”, and thus no further description will be given herein.

Alternatively, making the display screen of the mobile terminal operate in the low power consumption mode further comprises: comparing difference between picture information of a current frame and picture information of a previous frame, and transmitting a data signal only for pixels whose pixel luminance changes.

In the present embodiment, by transmitting only the data whose luminance (gray scale value) is changed in the picture pixels, the data transmission amount is reduced, and thus the power consumption is reduced.

The method of reducing power consumption of the mobile terminal provided in the embodiments of the present disclosure has following beneficial effects: by determining the operating mode of the mobile terminal, in a mode that requires relatively low performance of the mobile terminal, adopting at least one mode of reducing the MIPI transmission rate of the mobile terminal and making the display screen operate in the low power consumption mode to reduce overall power consumption of the mobile terminal.

FIG. 5 shows a block diagram of a system of reducing power consumption of to mobile terminal provided in an embodiment of the present disclosure. Referring to FIG. 5, there is provided in the embodiment of the present disclosure a system of reducing power consumption of the mobile terminal, comprising:

a determining unit 501, configured to determine whether picture information to be displayed currently in the mobile terminal belongs to picture information of a first mode, the picture information of the first mode being picture information of a low quality display requirement; and

a controlling unit 502, configured to reduce a transmission rate of a mobile industry processor interface of the mobile terminal and/or operating a display screen of the mobile terminal in a low power consumption mode when the picture information to be displayed currently belongs to the picture information of the first mode.

In the present embodiment, the first mode may be a text display mode, a picture display mode or a mode of a low quality display requirement prescribed by a user. Specifically, for example, a webpage display mode, an electronic book mode, a picture preview mode, etc.

It should be noted that if it is determined that the picture information to be displayed currently in the mobile terminal does not belong to the picture information of the first mode, for example, being a game mode or a video mode, then the controlling unit 502 can make the MIPI transmission rate of the mobile terminal satisfy the highest requirement, and the controlling unit 502 can also make the display screen operate in a state that satisfies the highest requirement. If the picture information belonging to the first mode is being displayed and the display screen of the mobile terminal has been already operated in the low power consumption mode, at this time, the controlling unit 502 can recover simultaneously the MIPI transmission rate of the mobile terminal to satisfy the highest requirement when the mode is converted into the game mode or the video mode, and of course, the controlling unit 502 can also recover the display screen of the mobile terminal to the state that satisfies the highest requirement, to which no further description is given herein.

In the present embodiment, by determining the operating mode of the mobile terminal, in the mode that requires relatively low performance of the mobile terminal, at least one mode of reducing the MIPI transmission rate of the mobile terminal and making the display screen operate in the low power consumption mode is adopted to reduce overall power consumption of the mobile terminal.

Alternatively, in order to make the display screen of the mobile terminal operate in a low power consumption mode, the controlling unit 502 can comprise:

an element for reducing a resolution ratio or refresh rate of the display screen of the mobile terminal.

In the present embodiment, the controlling unit 502 reduces the power consumption of the display screen by the element for reducing the resolution ratio or refresh rate of the display screen of the mobile terminal included therein, so that the overall power consumption of the mobile terminal is reduced.

Alternatively, the element for reducing the resolution ratio of the display screen of the mobile terminal can implement following functions:

within one frame time, making a data driving integrated circuit select only a part of data lines connected to the display screen to transmit data signals corresponding to picture information of the frame time, and/or making a gate driver on array (GOA) circuit or a gate driving integrated circuit select only a part of gate lines connected to the display screen to transmit gate driving signals. In the present embodiment, the resolution ratio is reduced by using only a part of data lines and/or only a part of gate lines for outputting, which reduces the power consumption of data driving chip or integrated circuit or gate driving chip or integrated circuit in the display screen, so that the overall power consumption of the mobile terminal is reduced.

Alternatively, the adjacent pixels connected to the data lines selected for transmission constitute vertical active display areas, the adjacent pixels connected to the data lines not selected for transmission constitute vertical inactive display areas, and the vertical active display areas and the vertical inactive display areas are arranged at intervals; and/or

the adjacent pixels connected to the gate lines selected for transmission constitute horizontal active display regions, the adjacent pixels connected to the gate lines not selected for transmission constitute horizontal inactive display areas, and the horizontal active display areas and the horizontal inactive display areas are arranged at intervals.

In the present embodiment, the resolution ratio of the display screen is reduced by using only a part of data lines and/or only a part of gate lines for transmission, and at the same time the display is made uniform and influence on the display effect is reduced by adjusting the distribution of the data lines and/or the gate lines which are not used for outputting.

Alternatively, in order to operate the display screen of the mobile terminal in a low power consumption mode, the controlling unit 502 can further comprise:

an element for comparing difference between picture information of a current frame and picture information of a previous frame, and transmitting data signals only for pixels whose pixel luminance changes.

In the present embodiment, the controlling unit controls the mobile terminal to transmit only the data whose luminance (gray scale value) changes in the picture pixels, so that data transmission amount is reduced, and power consumption is reduced.

The system of reducing power consumption of the mobile terminal provided in the embodiments of the present disclosure has following beneficial effects: by determining an operating mode of the mobile terminal, in a mode that requires relatively low performance of the mobile terminal, adopting at least one mode of reducing the MIPI transmission rate of the mobile terminal and operating the display screen in the low power consumption mode to reduce overall power consumption of the mobile terminal.

Obviously, those skilled in the art can make various alternations and modifications to the embodiments of the present disclosure without departing from the spirit and scope of the present disclosure. As such, if these alternations and modifications of the present disclosure belong to the scope of the claims of the present disclosure as well as the equivalent technology thereof, then the present disclosure also intends to contain these alternations and modifications.

The present application claims the priority of a Chinese patent application No. 201510424274.8 filed on Jul. 17, 2015. Herein, the content disclosed by the Chinese patent application is incorporated in full by reference as a part of the present disclosure.

1. A method of reducing power consumption of a mobile terminal, comprising:
determining whether picture information to be displayed currently in the mobile terminal belongs to picture information of a first mode, the picture information of the first mode being picture information of a low quality display requirement; and
reducing a transmission rate of a mobile industry processor interface of the mobile terminal and/or making a display screen of the mobile terminal operate in a low power consumption mode if the picture information to be displayed currently belongs to the picture information of the first mode.

2. The method according to claim 1, wherein the first mode comprises a text display mode and a picture display mode.

3. The method according to claim 1, wherein making the display screen of the mobile terminal operate in a low power consumption mode comprises:
reducing a resolution ratio or a refresh rate of the display screen of the mobile terminal.

4. The method according to claim 3, wherein reducing the resolution ratio of the display screen of the mobile terminal comprises:
within one frame time, making a data driving integrated circuit select only a part of data lines connected to the display screen to transmit data signals corresponding to picture information of the frame time, and/or making a gate driver on array (GOA) circuit or a gate driving integrated circuit select only a part of gate lines connected to the display screen to transmit gate driving signals.

5. The method according to claim 4, wherein adjacent pixels connected to the data lines selected for transmission constitute vertical active display areas, adjacent pixels connected to the data lines not selected for transmission constitute vertical inactive display areas, and the vertical active display areas and the vertical inactive display areas are arranged at intervals; and/or
adjacent pixels connected to the gate lines selected for transmission constitute horizontal active display areas, adjacent pixels connected to the gate lines not selected for transmission constitutes horizontal inactive display areas, and the horizontal active display areas and the horizontal inactive display areas are arranged at intervals.

6. The method according to claim 1, wherein making the display screen of the mobile terminal operate in a low power consumption mode further comprises: comparing difference between picture information of a current frame and picture information of a previous frame, and transmitting data signals only for pixels whose pixel luminance changes.

7. A system of reducing power consumption of a mobile terminal, comprising:
a determining unit, configured to determine whether picture information to be displayed currently in the mobile terminal belongs to picture information of a first mode, the picture information of the first mode being picture information of a low quality display requirement; and
a controlling unit, configured to reduce a transmission rate of a mobile industry processor interface of the mobile terminal and/or make a display screen of the mobile terminal operate in a low power consumption mode if the picture information to be displayed currently belongs to the picture information of the first mode.

8. The system according to claim 7, wherein the first mode comprises a text display mode and a picture display mode.

9. The system according to claim 7, wherein the controlling unit comprises:
means for reducing a resolution ratio or a refresh rate of the display screen of the mobile terminal, so that the display screen of the mobile terminal is operated in the low power consumption mode.

10. The system according to claim 9, wherein reducing the resolution ratio of the display screen of the mobile terminal comprises:
within one frame time, making a data driving integrated circuit select only a part of data lines connected to the display screen to transmit data signals corresponding to picture information of the frame time, and/or making a gate driver on array (GOA) circuit or a gate driving integrated circuit select only a part of gate lines connected to the display screen to transmit gate driving signals.

11. The system according to claim 9, wherein adjacent pixels connected to the data lines selected for transmission constitute vertical active display areas, adjacent pixels connected to the data lines not selected for transmission constitute vertical inactive display areas, and the vertical active display areas and the vertical inactive display areas are arranged at intervals; and/or
adjacent pixels connected to the gate lines selected for transmission constitute horizontal active display areas, adjacent pixels connected to the gate lines not selected for transmission constitute horizontal inactive display areas, and the horizontal active display areas and the horizontal inactive display areas are arranged at intervals.

12. The system according to claim 7, wherein the controlling unit further comprises:
means for comparing difference between picture information of a current frame and picture information of a previous frame, and transmitting data signals only for pixels whose pixel luminance changes.

13. The method according to claim 2, wherein making the display screen of the mobile terminal operate in a low power consumption mode further comprises: comparing difference between picture information of a current frame and picture information of a previous frame, and transmitting data signals only for pixels whose pixel luminance changes.

14. The method according to claim 3, wherein making the display screen of the mobile terminal operate in a low power consumption mode further comprises: comparing difference between picture information of a current frame and picture information of a previous frame, and transmitting data signals only for pixels whose pixel luminance changes.

15. The method according to claim 4, wherein making the display screen of the mobile terminal operate in a low power consumption mode further comprises: comparing difference between picture information of a current frame and picture information of a previous frame, and transmitting data signals only for pixels whose pixel luminance changes.

16. The method according claim 5, wherein making the display screen of the mobile terminal operate in a low power consumption mode further comprises: comparing difference between picture information of a current frame and picture information of a previous frame, and transmitting data signals only for pixels whose pixel luminance changes.

17. The system according to claim 8, wherein the controlling unit further comprises:
means for comparing difference between picture information of a current frame and picture information of a previous frame, and transmitting data signals only for pixels whose pixel luminance changes.

18. The system according to claim 9, wherein the controlling unit further comprises:
means for comparing difference between picture information of a current frame and picture information of a previous frame, and transmitting data signals only for pixels whose pixel luminance changes.

19. The system according to claim 10, wherein the controlling unit further comprises:
means for comparing difference between picture information of a current frame and picture information of a previous frame, and transmitting data signals only for pixels whose pixel luminance changes.

20. The system according to claim 11, wherein the controlling unit further comprises:
means for comparing difference between picture information of a current frame and picture information of a previous frame, and transmitting data signals only for pixels whose pixel luminance changes.
